(19) United States
(12) Patent Application Publication
(10) Pub. No.: US 2007/0144837 A1
(43) Pub. Date: Jun. 28, 2007

(54) BRAKE ACTUATOR WITH OFFSET INPUT LEVER AND OUTPUT MEMBER

(75) Inventors: Mark Van Ryswyck, Concord (CA); Simon Chan, Markham (CA); Steven Demoe, Leaskdale (CA); Peter Revelis, Newmarket (CA)

Correspondence Address: PILLSBURY WINTHROP SHAW PITTMAN, LLP, P.O. BOX 10500, MCLEAN, VA, 22102, US

(73) Assignee: Ventra Group Inc., Bradford (CA)

(21) Appl. No.: 11/564,020

(22) Filed: Nov. 28, 2006

Related U.S. Application Data
(60) Provisional application No. 60/740,280, filed on Nov. 29, 2005.

(51) Int. Cl. F16D 55/26

(52) U.S. Cl. 188/72.6; 188/73.1

(57) ABSTRACT

A brake actuator comprising: a mount including an input lever, a pivotal shaft; an operative output member connected to the shaft, a connector arm positioned adjacent the input lever and spaced axially from the output member; and an adjustable connection device, comprising: a link; a first connector connecting the link to the input lever, wherein the first connector comprises a seat provided on the input lever and supporting the link and a seat support structure between the input lever and the seat for supporting the seat; and a second connector connecting the link to the connector arm; to connect the input lever to the connector arm and the shaft via the link such that, when the output member is connected to one or more cables, movement of the input lever in either the applying or releasing directions pivots the shaft to apply or release tension to the cables. Further, the adjustable connection device enables adjustment of a distance along the link between the first connector connecting the link to the input lever and the second connector connecting the link to the connector arm to thereby pivot the shaft and the output member relative to the lever, allowing for adjustment of cable tension.

### CROSS-REFERENCE TO RELATED APPLICATIONS

This application claims the benefit of U.S. Provisional Application Ser. No. 60/740,280, filed Nov. 29, 2005, which application is incorporated herein by reference in its entirety.

### FIELD OF THE INVENTION

The present invention relates to a brake actuator with an offset input lever and output member.

### BACKGROUND OF THE INVENTION

FIGS. 1 and 2 are drawings disclosed to the applicants showing a brake actuator. These drawings may be regarded as prior art. A problem observed with this design was that the nut was not properly supported and as such could not act to move the threaded rod as illustrated. Also, another problem observed was that the pivot on the rod would disengage from the slot in the connector arm with the slightest lateral force.

The present invention endeavors to provide an improved and effective brake actuator with an offset input lever and output member.

### SUMMARY OF THE INVENTION

One aspect of the invention provides a brake actuator for use in a motor vehicle having one or more brakes and a cable system with one or more cables for actuating the brakes. The actuator comprises a mount constructed to be mounted in the vehicle, and an input lever movably mounted to the mount. The lever is movable in applying and releasing directions. A shaft is pivotally mounted to the mount for pivotal movement about an axis. An output member is connected to the shaft and is constructed to be operatively connected to the one or more cables. A connector arm is connected to the shaft. The connector arm is positioned adjacent the input lever and spaced axially from the output member.

An adjustable connection device comprises:

(i) a link;

(ii) a first connector connecting the link to the input lever, wherein the first connector comprises a seat provided on the input lever and supporting the link and a seat support structure between the input lever and the seat for supporting the seat; and

(iii) a second connector connecting the link to the connector arm,

The adjustable connection device is constructed to connect the input lever to the connector arm and the shaft via the link such that, when the output member is operatively connected to the one or more cables, (a) movement of the input lever in the applying direction pivots the shaft in a first direction to apply tension to the one or more cables, and (b) movement of the input lever in the releasing direction pivots the shaft in a second direction to reduce tension in the one or more cables. Further, the adjustable connection device is constructed to enable adjustment of a distance along the link between the first connector connecting the link to the input lever and the second connector connecting the link to the connector arm to thereby pivot the shaft and the output member relative to the lever, thus allowing for adjustment of cable tension.

Other objects, features, and aspects of the present invention will be appreciated from the following detailed description, the accompanying drawings, and the appended claims.

### BRIEF DESCRIPTION OF THE DRAWINGS

FIG. 1 is a drawing of a brake actuator, which drawing may be regarded as prior art;

FIG. 2 is another drawing of a brake actuator, which drawing may be regarded as prior art;

FIG. 3 is a perspective view of a brake actuator according to a first embodiment of the invention;

FIG. 4 is a close-up view of components of the brake actuator of FIG. 3;

FIG. 5 is a perspective view of a brake actuator according to a second embodiment of the invention;

FIG. 6 is a close-up view of components of the brake actuator of FIG. 5;

FIG. 7 is a close-up view of components of the brake actuator of FIG. 5;

FIG. 8 is a perspective view of the brake actuator of FIG. 5 from beneath the actuator;

FIG. 9 is a close-up view of the connector arm and trunion in the brake actuator of FIG. 5; and

FIG. 10 is yet another close-up view of the brake actuator of FIG. 5.

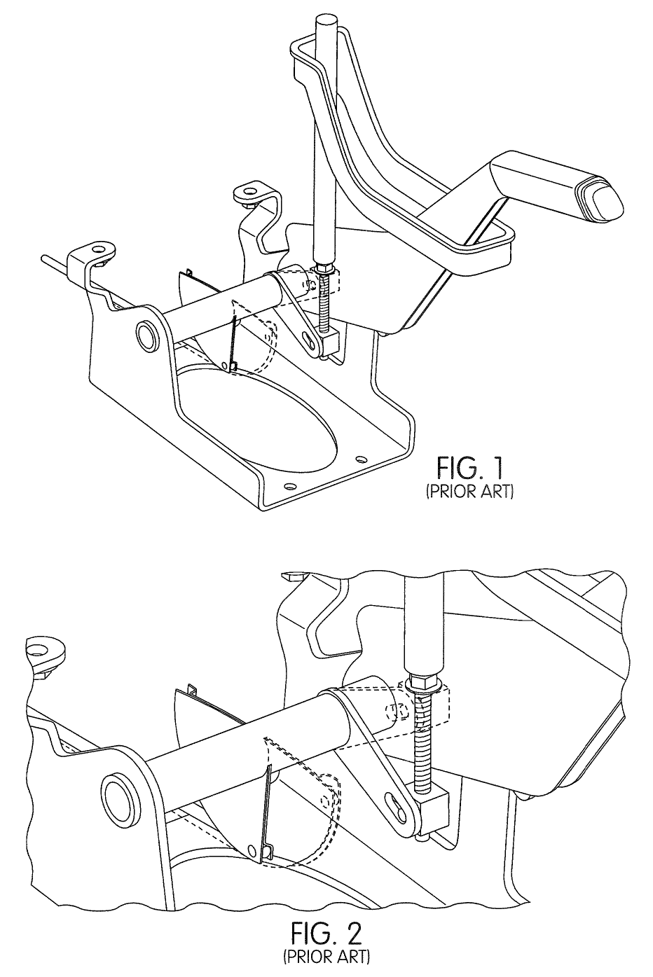

### DETAILED DESCRIPTION OF THE ILLUSTRATED EMBODIMENTS

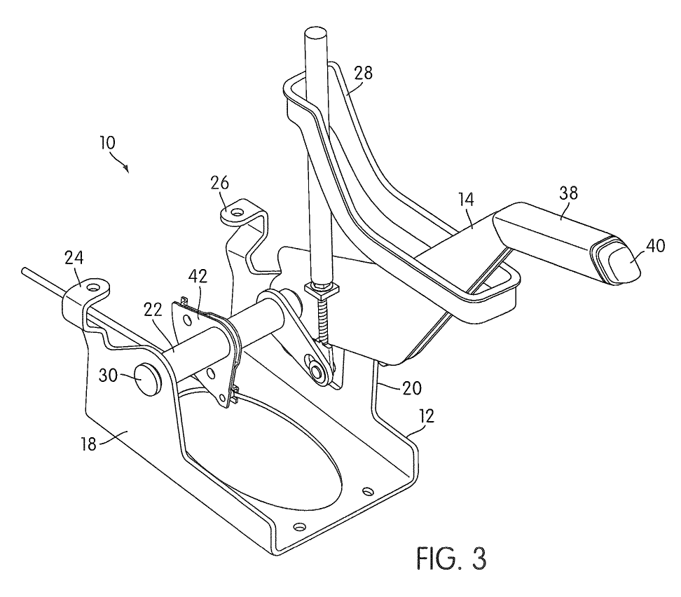

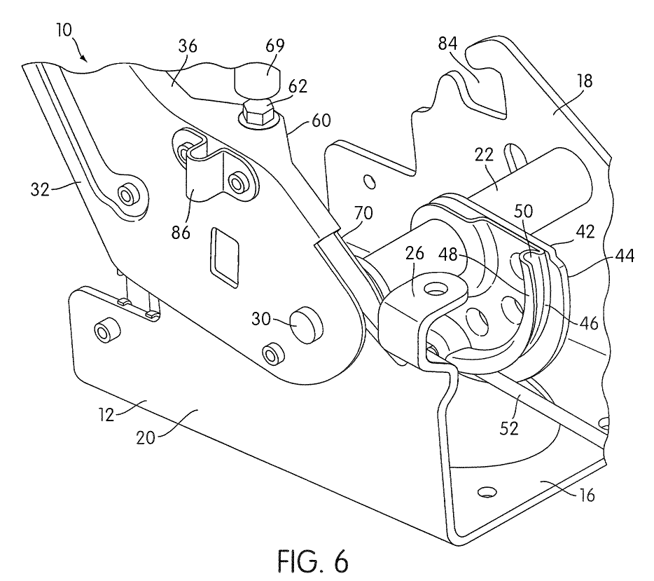

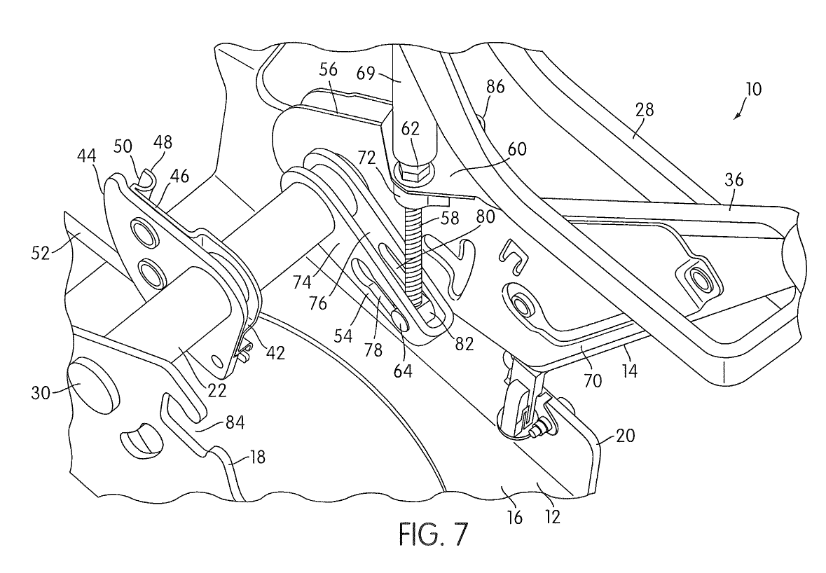

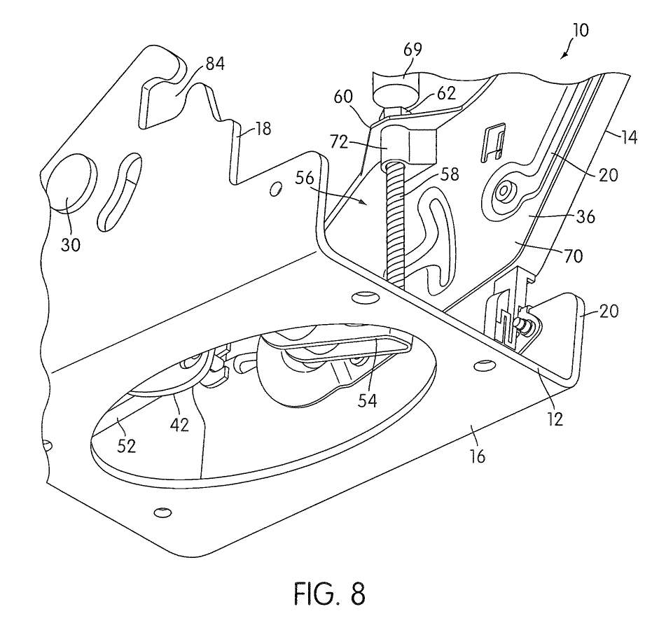

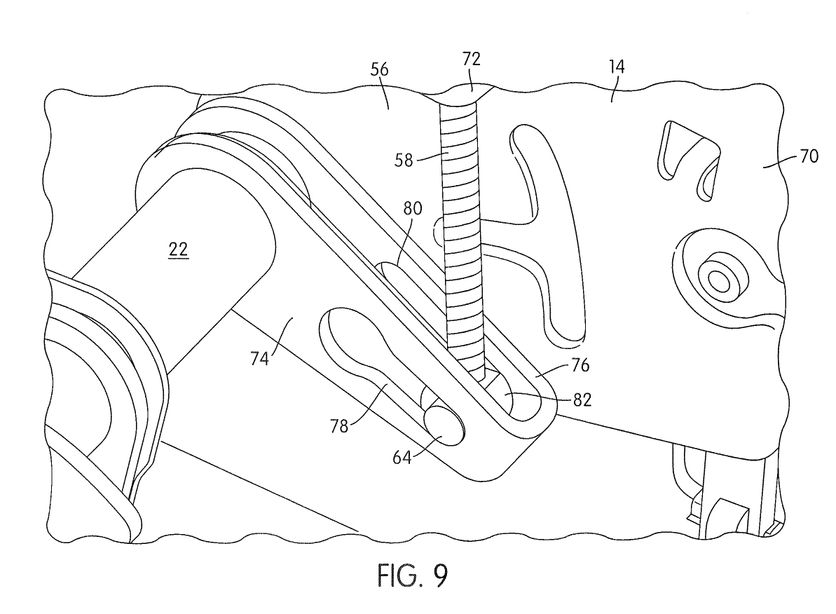

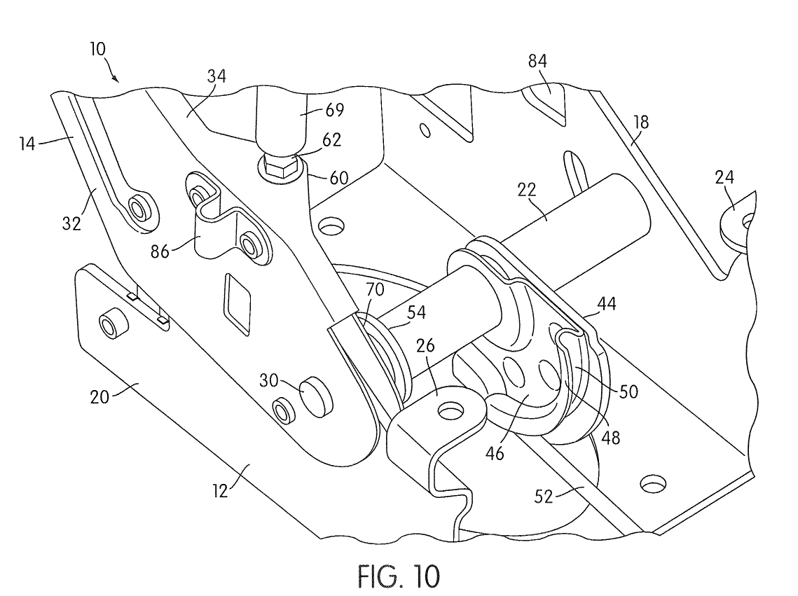

FIGS. 3-10 illustrate non-limiting examples of embodiments of the present invention. In general, the present invention is a brake actuator for use in a motor vehicle having one or more brakes and a cable system with one or more cables for actuating the brakes. The general operation of a motor vehicle, its brakes, and the cable system for actuating such cables is well-known in the art and need not be described herein. Such brake actuators are often referred to as parking or emergency brakes, as they are typically used to mechanically activate the vehicle brakes without using powered assistance from the vehicle.

The illustrated embodiments shown are hand-operated actuators that are designed for installation in the passenger compartment of the vehicle. Typically, such an actuator is mounted between the driver and passenger seats so that it can be easily accessed and operated by the driver. This location of such actuators is well known and need not be described in detail. Other versions may be directed to foot-operated brake actuators.

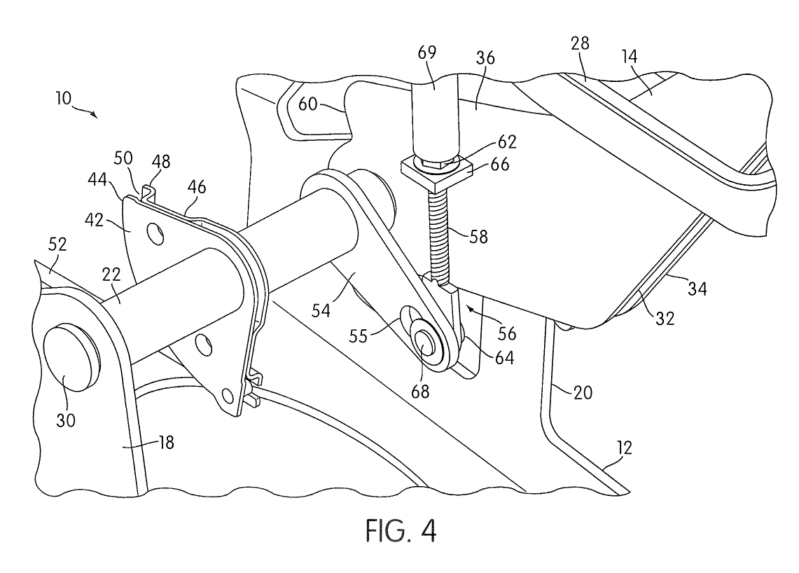

Referring to the embodiment of FIGS. 3-4, the actuator is generally indicated at 10. The actuator 10 comprises a mount 12 constructed to be mounted in the vehicle, and an input lever 14 movably mounted to the mount 12.

As can be seen in the Figures, the mount 12 is in the form of a mounting bracket. The mount 12 may be formed from any material and in any manner. The mount 12 has a bottom wall 16, and a pair of generally vertical side walls 18, 20 extending upwardly from the bottom wall 16.

Each wall 18, 20 has an opening formed therethrough, and a shaft 22 is pivotally received in those openings. The shaft 22 will be discussed further below.

Each wall 18, 20 also have a pair of attachment members 24, 26 extending upwardly therefrom with portions extending inwardly. These attachment members 24, 26 are provided for allowing a cover (not shown) that encases the actuator to be attached thereto. Such covers are well-known and are generally design with an aesthetic configuration and finish that matches the vehicle interior. A part of the cover is shown, and this is the rim 28 that surrounds the opening through which the lever 14 extends. That is, the lever 14 extends outwardly from the cover so that it can be grasped and operated by the driver of the vehicle, and the rim 28 is being shown to illustrate this relationship (and the cover is removed so that the remainder of the actuator 10 can be seen). The rim 28 may be an integral part of the cover, or it may be a separate piece mounted to the cover for purposes of protecting the edge of the cover opening from wear.

In the illustrated embodiment, the mount is stamped and folded from a single piece of metal such that the bottom wall 16 and the walls 18, 20 are integrally formed together as one-piece. In general, the mount 12 may have any construction and configuration and the invention is not limited to the one illustrated.

The shaft 22 is pivotally mounted to the mount 12 for pivotal movement about an axis. Specifically, the ends of the shaft 22 is tubular and is received on an axle 30 that extends between the walls 18, 20 of the mount 12. The axle 30 may also be referred to as a rivet. The ends of the axle 30 are received in the bores or openings on the mount walls 18, 20. To make this connection, a free end of the axle 30 may be inserted into the bore of one wall, then through the interior of the shaft 22, and then through the opening in the other wall. A flanged fastener may be attached to the free end of the axle 30 and the other end may likewise be flanged as illustrated to prevent the same from withdrawing through the openings. Alternatively, the ends of the axle 30 may be deformed to create flanges for this purpose. Further, any other suitable manner of pivotally connecting the shaft 22 may be used, and the illustrated or described ways of achieving this are not limiting.

The input lever 14 is movably mounted to the mount 12 for movement in applying and releasing directions. The applying direction in the illustrated embodiment is where the user raises the lever 14 upwardly to an applied position, and the releasing direction is where the user lower the lever 14 back to its home position (which is the position illustrated). In the illustrated embodiment, the lever 14 is pivotally mounted on the wall 20. The lever 14 has a pair of side walls 32, 34 that are positioned on each side of the wall 20. Each wall 14 has an opening therethrough. These openings are received on the shaft 22 and/or its axle 30 to pivotally mount the lever 14. However, the lever 14 is not fixed to the shaft 22, and thus can pivot relative to the shaft 22 and the mount 12. Other ways of mounting the lever 14 may be used. For example, the lever 14 need not be mounted for pivotal movement about an axis that is coaxial with the shaft 22 (i.e., about a common axis); and instead, it may be mounted for pivoting about a separate parallel axis for providing a varying mechanical ratio. Also, the lever 14 need not be mounted for simple pivotal movement as illustrated.

The illustrated lever 14 is stamped from a single piece of metal, and thus the side walls 32, 34 are integral and one piece with a top wall 36. A hand grip 38 of molded plastic or any other material is provided on the end of the lever 14. A depressible button 40 is provided on the end of the grip 38. The button 40 operates a rod (not shown) or other structure that transmits motion to a pawl (not shown). The pawl engages sector teeth provided on wall 20 in a ratcheting manner to secure the lever in its applied position. Such retainer mechanisms for retaining the lever in an applied position are well known. Other mechanisms may be used to retain the lever 14 in an applied position. Reference may be made to U.S. Pat. Nos. 6,718,836, 6,286,389 and 6,282,980, for examples of suitable mechanisms, and these are incorporated into the present application in their entirety by reference.

The lever 14 may have any suitable construction or configuration, and the present invention is not intended to be limited to the construction illustrated or described.

An output member 42 is connected to the shaft 22 and is constructed to be operatively connected to the one or more cables of the vehicle's cable system. Specifically, the output member 42 is connected to the shaft 22 at a point spaced axially from the lever 14. The connection is fixed, such as by welding or other suitable means, so that the output member 42 rotates with the shaft 22.

In the illustrated embodiment, the output member 42 comprises two plates 44, 46. Plate 44 mounts the output member 42 to the shaft 22, and plate 46 is secured to plate 44. Plate 46 has a flange 48 bent to create a recess 50 for receiving a lead cable 52 of the vehicle cable system. The general shape of the flange 48 and the recess 50 is arcuate, such that the output member 42 operates as a reel for taking up the cable 52 to increase tension in the cable system, and for unwinding the cable 52 for reducing tension in the cable system. This type of output member 42 is often called a cam in the industry. The output member 42 may have any shape or configuration, and the illustrated embodiment is not intended to be limiting.

A connector arm 54 is connected to and extends generally radially from the shaft 22. The connector arm is fixed to the shaft 22, such as by welding at the opening through which the shaft 22 is received, or any other suitable means. The connector arm 54 is positioned adjacent the input lever 14 and is spaced axially from the output member 42. The axial spacing between the output member 42, the lever 14, and the connector arm 54 may be selected based on design choice and no specific spacing is required. Factors driving the design choice may include, but are not limited, the location of components in the vehicle passenger compartment, routing for the cable system, location of operative components of the vehicle beneath the floorboard, etc.

The connector arm 54 has an elongated slot 55 at the free end thereof for connecting to the adjustable connection device 56, described below. However, the connector arm 54 may have any suitable construction or configuration, and the illustrated construction is not intended to be limiting.

The actuator 10 further comprises an adjustable connection device 56 comprising: (i) a link in the form of a threaded rod 58, (ii) a first connector connecting the threaded rod 58 to the input lever 14, (iii) a rotatable adjustment input member 62 connected to the threaded rod 58, and (iv) a second connector connecting the threaded rod 58 to the connector arm 54. The first connector 60 is a seat 60 that engages the rotatable adjustment input member 62, and the second connector is a pivotal connector 64 pivotally connecting the threaded rod 58 to the connector arm 54. Other suitable connectors may be used.

The adjustable connection device 56 connects the input lever 14 to the connector arm 54 and the shaft 22 via the threaded rod 58. As a result, when the output member 42 is operatively connected to the one or more cables (i.e., to the lead cable 52), (a) movement of the input lever 14 in the applying direction pivots the shaft 22 in a first direction to apply tension to the one or more cables, and (b) movement of the input lever 14 in the releasing direction pivots the shaft 22 in a second direction to reduce tension in the one or more cables. That is, the adjustable connection device 56 connects the input lever 14 to the output member 42 via the shaft 22 and the connector arm 54 for transmitting movement of the lever 14 to the output member 42 for increasing/decreasing tension in the cable system for purposes of applying or releasing the vehicle brakes.

The adjustable connection device 56 is also constructed such that rotating the rotatable adjustment input member 62 adjusts a distance along the threaded rod 58 between the seat 60 provided on the input lever 14 and the pivotal connector 64 on the connector arm 54. This in turn pivots the shaft 22 and the output member 42 relative to the lever 14, thus allowing for adjustment of cable tension. Specifically, during installation of the actuator 10, and possibly later during vehicle servicing, it is desirable to adjust the tension in the cable system to a pre-set target. For example, if the vehicle brakes requires a certain amount of tension to be applied, it is desirable to set the tension of the cable system in the home position of the lever 14 at a level such that movement of the lever 14 to its fully applied position will exceed the tension for actuating the vehicle brakes to ensure their actuation. Likewise, the tension of the cable system should not be so high that the brakes are actuated (fully or even partially) when the lever 14 is in the home position. Thus, adjustability of the cable tension of by the adjustable connection device 56 is a desirable feature.

In the illustrated embodiment, the seat 60 extends laterally from the input lever 14. As shown, the seat 60 is in the form of a tab 66. The tab 66 may be separately formed and attached to the lever 14, or integrally formed as one piece with the input lever 14. The seat 60 may have any suitable construction or configuration, and the illustrated construction is not limiting.

In the embodiment of FIGS. 3-4, the rotatable adjustment input member 62 has an internal threaded bore threaded onto the threaded rod 58, and the pivotal connector 64 is fixed on the threaded rod 58. The rotatable input member 62 may be a multi-sided nut as illustrated, or any other suitable structure. The pivotal connector 64 has a bearing 68 rotatably and slidably received in the slot 55 of the connector arm 54. As a result of this construction, rotation of the rotatable adjustment input member 62 causes the rod 58 to travel axially within its internal threaded bore to adjust a distance along the threaded rod 58 between the seat 60 provided on the input lever 14 and the pivotal connector 64 on the connector arm 54. Specifically, rotation of the input member 62 in one direction will cause the rod 58 to travel upwardly, bringing the pivotal connector 64 and the end of the connector arm 54 closer to the seat 60; and rotation of the input member 62 in the other direction will cause the rod 58 to travel downwardly, moving the pivotal connector 64 and the end of the connector arm 54 away from the seat 60.

The positioning of the rotatable input adjustment member 62 on the lever 14 is desirable as it may provide relatively easy access for adjusting. Specifically, there is no need to access a nut or other input adjustment member on the output member 42, and the lever 14 provides an easier access location. This is not a necessary or limiting feature. Also, in the illustrated embodiment the input member 62 is shown as being beneath the opening in the cover. This allows a service person or installer to directly engage that adjustment member through the opening with a tool, such as the socket of a torque gun. An extended socket 69 is illustrated to show this access. The use of torque guns for adjusting cable tension is well known.

Although the link in the illustrated embodiment is a threaded rod, other types of links may be used. For example, the link could be a cable. In such an embodiment, one of the connectors could be a cable clutch that grips the cable, but allows for the cable to be pulled therethrough for adjusting the cable length provided between the first and second connectors. Likewise, a rigid, elongated member that is adjustably and linearly movable to provide the adjustability.

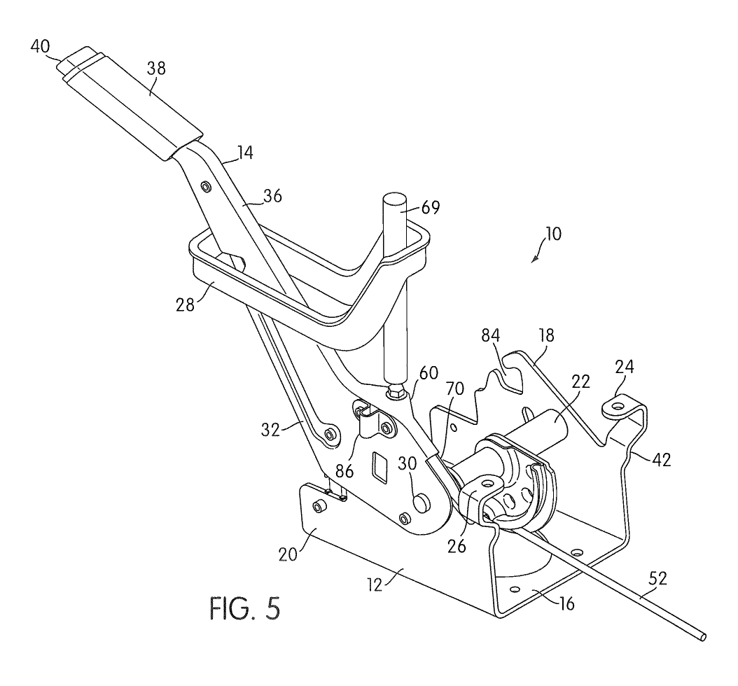

The embodiment of FIGS. 5-10 is similar to the previous embodiment in many respects, and thus similar reference numbers will be used to denote similar or identical structures. A description of common features is not being repeated, and the discussion of this second embodiment will focus on the differences.

In this second embodiment, the lever 14 has a two part construction, with a separate inner wall 70 attached to the lever 14. The top wall 36 is integral with the outer wall 32, and the seat 60 is formed as a tab or flange extending integrally as one-piece from the top wall 36. This seat 60 may also be provided as an entirely separate piece. The threaded rod extends through an opening in the seat 60.

A seat support structure 72 is attached to the input lever 14 beneath the seat 60. This seat support structure 72 engages the seat 60 and supports it to prevent deflection of the seat 60. Specifically, because load will be transferred from the rod to the seat 60, this support structure 72 supports the seat 60 to resist deflection from that load in the general direction of the rod/link. In the illustrated embodiment, this seat support structure 72 is a U-shaped member stamped or punched from the wall 70, and thus is formed integrally as one-piece therewith. The lower surface of the seat 60 is engaged atop the seat support structure 72, thus providing the support. The U-shape of the support structure 72 accommodates passage of the rod 58 therethrough. Having the longitudinal extent of the seat support structure in the general direction of the rod is desirable for increasing strength and support The seat support structure 72 may have any construction or configuration, and is not limited to the construction disclosed. Stamping the support structure 72 from the wall 70 is desirable because it simplifies manufacturing, but it is within the scope of the invention to provide the seat support structure 72 as a separate component attached to the wall 70 by fasteners, welding, or other suitable means. Also, it is envisioned that the top surface of the seat support structure 72 may provide the seat itself and the structure underneath supporting that surface, such that the use of a flange for seat 60 may be eliminated.

The connector arm 54 in this second embodiment is also different in that it has two spaced arms 74, 76 connected together at their free ends. Each arm 74, 76 is welded to the shaft 22 (or otherwise attached) at the openings through which the shaft 22 is received. Each arm 74, 76 also has an elongated slot 78, 80.

The pivotal connector 64 in this second embodiment is in the form of a trunion 82. Each end of the trunion 82 is pivotally and slidably received in the slots 78, 80 of the arms 74, 76 of the connector arm 54. This establishes a pivoting and sliding connection similar to the bearing in the first embodiment.

The trunion 82, or other pivotal connector 64, has an internal threaded bore threaded onto the threaded rod. The rotatable adjustment input member 62 is fixed on the threaded rod 58, as opposed to being rotatable on the rod 58 as in the first embodiment. As a result of this construction, rotation of the rotatable adjustment input member 62 rotates the rod 58 and causes the trunion 82 to travel axially along the rod 58. This adjusts the distance along the threaded rod 58 between the seat 60 provided on the input lever 14 and the trunion 82 on the connector arm 54. The adjustment provided is similar to that achieved in the first embodiment, but this construction is beneficial in that the “excess length” of the rod 58 that travels extends below the trunion 82, which is in an area where excess rod length can be more easily accommodated. In the first embodiment, because the excess rod length extends above the nut, care must be taken that the rod does not contact the cover of the actuator. Also, an excessive length of rod above the nut in the first embodiment may interfere with engagement of a tool, such as the torque gun socket 69, onto the nut.

In the illustrated embodiment, the threaded rod 58 is an elongated bolt and the rotatable adjustment input member 62 is a head fixed on the bolt. The rod 58 and input member 62, however, may have any suitable construction or configuration, and the illustrated embodiment is not intended to be limiting.

As an optional feature, the mount 12 in this second embodiment is designed to allow for two different installation positions of the lever 14—one on the left wall 18 and one on the right wall 20. Each of these walls 18, 20 may be referred to generically as a first mounting portion and a second mounting portion, and they are spaced apart from one another with the shaft 22 therebetween. Each wall has a sector mounting portion 84, which is designed to receive the sector discussed above that is engaged by the pawl on the lever 14. The manner in which the sector is mounted is well-known, and need not be described herein. The sector would be mounted to the respective portion 84 of which the lever 14 is to be mounted. If the sector is formed as one piece with the mount, it would be possible to form two integral sectors—one on each wall.

The seat 60 is a first seat provided on a first lateral side of the input lever 14, and the adjustable connection device comprises a second seat 87 provided on a second lateral side of the input lever 14. Like the first seat 60, the second seat 87 is configured for engaging the rotatable adjustment input member 62 when the input lever is mounted to the second wall 18 of the mount 12. In the illustrated embodiment, the second seat 87 is the upper edge of a seat support structure 86 formed as a U-shaped member attached to the lever 14 on the side wall 34 thereof, but it may be formed as one integral piece similarly to the seat 60 and/or the seat support structure 72. With this construction, the lever 14 can be mounted to wall 18 instead of wall 20, the connector arm 54 would be connected at the opposite end of the shaft 22, and the seat 87 would therefore operate the same way as seat 60 described above.

The various features of these embodiments may be interchanged with one another. Moreover, the illustrated embodiments have been provided solely to illustrate examples within the scope of the invention and are in no way intended to be limiting. To the contrary, the present invention is intended to encompass all modifications, alterations, substitutions, and equivalents within the spirit and scope of the appended claims.

What is claimed:

1. A brake actuator for use in a motor vehicle having one or more brakes and a cable system with one or more cables for actuating the brakes, the actuator comprising:
a mount constructed to be mounted in the vehicle;
an input lever movably mounted to the mount, the lever being movable in applying and releasing directions;
a shaft pivotally mounted to the mount for pivotal movement about an axis;
an output member connected to the shaft and being constructed to be operatively connected to the one or more cables;
a connector arm connected to the shaft, the connector arm being positioned adjacent the input lever and being spaced axially from the output member; and
an adjustable connection device comprising:
(i) a link;
(ii) a first connector connecting the link to the input lever, wherein the first connector comprises a seat provided on the input lever and supporting the link, and a seat support structure between the input lever and the seat for supporting the seat; and
(iii) a second connector connecting the link to the connector arm;
the adjustable connection device being constructed to connect the input lever to the connector arm and the shaft via the link such that, when the output member is operatively connected to the one or more cables, (a) movement of the input lever in the applying direction pivots the shaft in a first direction to apply tension to the one or more cables, and (b) movement of the input lever in the releasing direction pivots the shaft in a second direction to reduce tension in the one or more cables;
the adjustable connection device being constructed to enable adjustment of a distance along the link between the first connector connecting the link to the input lever and the second connector connecting the link to the connector arm to thereby pivot the shaft and the output member relative to the lever, thus allowing for adjustment of cable tension.

2. A brake actuator according to claim 1, wherein the link is a threaded rod, and wherein the adjustable connection device further comprises a rotatable adjustment input member connected to the threaded rod,
the adjustable connection device being constructed such that rotating the rotatable adjustment input member adjusts the distance along the threaded rod between the first and second connections.

3. A brake actuator according to claim 2, wherein the rotatable adjustment input member engages the seat so that the seat supports the link, and wherein the second connector is a pivotal connector pivotally connecting the threaded rod to the connector arm.

4. A brake actuator according to claim 3, wherein the seat extends laterally from the input lever.

5. A brake actuator according to claim 4, wherein the seat is a tab integrally formed as one piece with the input lever.

6. A brake actuator according to claim 4, wherein the seat support structure is separate from the seat and provided on the input lever beneath the seat, the seat support structure engaging the seat to prevent deflection of the seat.

7. A brake actuator according to claim 5, wherein the seat support structure is separate from the seat and provided on the input lever beneath the seat, the seat support structure engaging the seat to prevent deflection of the seat.

8. A brake actuator according to claim 2, wherein the output member is a reel with a recess for receiving a cable of the cable system.

9. A brake actuator according to claim 3, wherein the rotatable adjustment input member has an internal threaded bore threaded onto the threaded rod and wherein the pivotal connector is fixed on the threaded rod such that rotation of the rotatable adjustment input member causes the rod to travel axially within the internal threaded bore to adjust the distance along the threaded rod between the seat provided on the input lever and the pivotal connector on the connector arm.

10. A brake actuator according to claim 9, wherein the rotatable adjustment input member is a multi-sided nut.

11. A brake actuator according to claim 3, wherein the pivotal connector has an internal threaded bore threaded onto the threaded rod and wherein the rotatable adjustment input member is fixed on the threaded rod such that rotation of the rotatable adjustment input member causes the pivotal connector to travel axially along the rod to adjust the distance along the threaded rod between the seat provided on the input lever and the pivotal connector on the connector arm.

12. A brake actuator according to claim 11, wherein the threaded rod is an elongated bolt and wherein the rotatable adjustment input member is a head fixed on the bolt.

13. A brake actuator according to claim 3, wherein the mount has a first mounting portion and a second mounting portion, the first and second mounting portions being spaced apart from one another with the shaft therebetween,
the seat being a first seat provided on a first lateral side of the input lever, and the input lever being mounted to the first mounting portion of the mount;
the adjustable connection device comprising a second seat provided on a second lateral side of the input lever, the second seat being configured for engaging the rotatable adjustment input member when the input lever is mounted to the second mounting portion of the mount.
